(19) United States
(12) Patent Application Publication
(10) Pub. No.: US 2005/0106546 A1
(43) Pub. Date: May 19, 2005

(54) Electronic communications device with a karaoke function

(76) Inventor: George Strom, Lejre (DK)

Correspondence Address: BURNS DOANE SWECKER & MATHIS L L P, POST OFFICE BOX 1404, ALEXANDRIA, VA, 22313-1404, US

(21) Appl. No.: 10/490,631

(22) PCT Filed: Sep. 13, 2002
(86) PCT No.: PCT/EP02/10396

Related U.S. Application Data
(60) Provisional application No. 60/327,319, filed on Oct. 9, 2001.

(30) Foreign Application Priority Data
Sep. 28, 2001 (EP) 01610102.4

(51) Int. Cl. G10H 1/36

(52) U.S. Cl. 434/307 A

(57) ABSTRACT

A method of performing a karaoke function from an electronic communications device comprises the steps of reading music data and providing a music signal, reading text data and presenting text on a display, receiving a voice signal, providing a first output signal comprising the music signal, providing a second output signal by mixing the music signal and the voice signal, and reproducing the first output signal for the user. The second output signal is further transmitted wirelessly from the electronic communications device to at least one further communications device, wherein the second output signal is received and reproduced for an audience. People listening to these further devices may be located at any location and still participate in the karaoke performance. Thus a more flexible karaoke performance is possible without restricting the participants to people located in one single location.

### TECHNICAL FIELD OF THE INVENTION

The invention relates to a method of performing a karaoke function from a first electronic communications device, said method comprising the steps of reading music data and providing a corresponding music signal, reading text data and presenting corresponding text on a display, receiving a voice signal representing the voice of a user, providing a first output signal comprising at least the music signal, providing a second output signal by mixing of the music signal and the voice signal, and reproducing said first output signal for the user. The invention further relates to a system for performing a karaoke function and comprising a first electronic communications device and at least one further communications device. The invention further relates to a karaoke device.

### DESCRIPTION OF RELATED ART

The idea of karaoke or sing-along is that of a person singing along with pre-recorded music in such a way that the person and/or an audience can listen to the voice of the singing person in combination with the pre-recorded music. A karaoke system or device will typically include a music player for replaying the pre-recorded music, a device for showing the text of the song synchronized with the replayed music, and equipment for electronic amplification of the singer's voice and for mixing it with the music before being played through a number of loudspeakers. The device for showing the text may include a moving pointer showing the precise point in the text which fits the music played at the precise moment, and further some devices also allow for mood setting pictures to be shown together with the text of the song.

The mixing of the singer's voice with the music before being played is included in most systems because an important aspect of karaoke is the manner in which the singer hears his or her own voice. In order to improve the experience of the singer—and the singer's confidence—it is often preferred to offer some sort of enhanced feedback, electronic improvement and amplification of the voice. This means that the singer does not hear the music separately, but instead the music combined with an enhanced version of his or her own voice.

An example of a known karaoke device is a dedicated karaoke machine with a HiFi microphone to capture the song and a HiFi mixer, amplifier and loudspeaker system, and with the option of showing the text and mood creating pictures (if used) on a television screen. However, such a dedicated karaoke machine is relatively expensive, even compared to entertainment systems offering the same music and picture quality. Further, such a machine is a heavy device and thus will typically only be used as a stationary device, also because of the power supply needed.

A more simple solution is the use of a normal television set with a video tape player. The text and the mood creating pictures are then displayed on the television screen and the music is transmitted through the loudspeakers of the television set. This solution does not include an electronic capture and amplification of the singer's voice, and thus no enhanced feedback to the singer is provided. Also this system is typically a stationary system.

A personal computer (PC) or a similar type of computer may also be used. The music can be stored in the computer in a format like e.g. the Midi format and replayed in parallel with the display of the song text on the display monitor of the computer. However, a PC is not designed to be used as a home entertainment system, and thus its performance is not well suited for this application, and the total experience may be degraded by technical problems. As for the television/video tape solution no feedback to the singer is available. Again, this is typically a stationary solution. Although a portable computer may be used, the quality of the music will typically be further degraded due to a lower quality of the built-in loudspeaker.

JP 11-7290 describes a karaoke device which can be connected to a portable telephone set through a cable. A request for a specific piece of music can be transmitted from the karaoke device via the portable telephone set, a base station and a telephone switching network to a musical piece data base, and the requested piece of music can then be transmitted in the opposite direction. This allows the device to select between a large number of different pieces of music stored in the musical piece data base even in places where a normal telephone line is not available. However, the karaoke device itself is still a stationary device.

A similar system is known from U.S. Pat. No. 6,083,009 in which karaoke data can be downloaded from a database through a mobile telephone connected to the device. The user of the device can select between music stored in the device and music downloaded from the data base. The device is also connected to a television receiver, an audio system and a computer, so also here the system is for stationary use.

In KR 96 11827 an apparatus adding the karaoke function to a telephone is disclosed. A CPU controls the general function of the phone as well as the karaoke function. The apparatus also has a micro tape for storing music data and a control circuit for mixing voice and music and outputting the signal to a speaker. By using the audio function of the telephone the karaoke function can be realized cheaper without an ordinary audio system.

All the systems mentioned above require that all the persons participating in the karaoke performance are present at one location, i.e. the room or location in which the system is placed. Although karaoke performances have traditionally been restricted in this way, this seems to be an unwanted limitation today where most people are used to a very flexible communication between people by means of mobile telephones, etc.

Therefore, it is an object of the invention to provide a method of the above-mentioned type in which a more flexible karaoke performance is possible without restricting the participants to people located at one single location.

### SUMMARY

According to the invention the object is achieved in that the method further comprises the steps of wirelessly transmitting said second output signal from the first electronic communications device to at least one further communications device, receiving said second output signal in the at least one further communications device, and reproducing said second output signal for an audience in the at least one further communications device.

When the second output signal, which is intended for an audience, is transmitted to one or more other communications devices, it is ensured that people listening to these devices may be located at any location and still participate in the karaoke performance, as long as the location can be reached by the communication. By using several devices a corresponding number of locations can be covered, and thus a very flexible method is achieved.

When the first electronic communications device is a portable device an even more flexible method is achieved, because the device can be carried by the user, even if he moves around from one location to another. In an expedient embodiment of the invention the first portable, electronic communications device is a mobile telephone.

Also the at least one further communications device may comprise a mobile telephone, which provides the other participants, i.e. the audience, with the same flexibility as the singer.

In one embodiment of the invention the step of reading music data comprises reading data stored in the first electronic communications device. Having the data stored in the device means that the device is always ready for a karaoke performance. As an alternative the step of reading music data may comprise streaming of data from a server to the first electronic communications device. The possibility of receiving data from a remote server provides a much larger selection of different songs for the karaoke performance. The data from the server may also be downloaded to the device.

The voice signal of the user, i.e. the singer, may be received by a microphone integrated in the first electronic communications device. In an alternative embodiment the receiving of the voice signal comprises the use of a microphone in a headset connected to the first electronic communications device. The use of the microphone in a headset reduces the risk of acoustic feedback from microphone to loudspeaker, and in many situations the headset is also more convenient for the user.

Similarly, the output signal to the user may be reproduced through a loudspeaker integrated in the first electronic communications device, or the reproduction of the first output signal for the user may comprise the use of a loudspeaker in a headset connected to the first electronic communications device. Also the use of the loudspeaker in a headset reduces the risk of acoustic feedback from microphone to loudspeaker, and again the headset is often more convenient for the user.

As mentioned, the invention also relates to a system for performing a karaoke function and comprising a first electronic communications device and at least one further communications device, wherein said first electronic communications device comprises a display, circuitry for reading text data and presenting corresponding text on said display, circuitry for reading music data and providing a corresponding music signal, circuitry for receiving a voice signal representing the voice of a user, circuitry for providing a first output signal comprising at least the music signal, and circuitry for providing a second output signal by mixing of the music signal and the voice signal.

When the first electronic communications device further comprises a transmitter for wireless transmission of said second output signal to the at least one further communications device, and the at least one further communications device comprises a receiver for receiving said second output signal and means for reproducing said second output signal for an audience, people listening to these devices may be located at any location and still participate in the karaoke performance, as long as the location can be reached by the communication. By using several devices a corresponding number of locations can be covered, and thus a very flexible method is achieved.

When the first electronic communications device is a portable device an even more flexible system is achieved, because the device can be carried by the user, even if he moves around from one location to another. In an expedient embodiment of the invention the first portable, electronic communications device is a mobile telephone.

Also the at least one further communications device may comprise a mobile telephone, which provides the other participants, i.e. the audience, with the same flexibility as the singer.

The first electronic communications device may comprise circuitry for reproducing the first output signal for the user. Alternatively, the circuitry for reproducing the first output signal may be adapted for connection to a loudspeaker in a headset connected to the first electronic communications device. The use of the loudspeaker in a headset reduces the risk of acoustic feedback from microphone to loudspeaker, and in many situations the headset is also more convenient for the user.

Similarly, the voice signal of the user, i.e. the singer, may be received by a microphone integrated in the first electronic communications device. In an alternative embodiment the circuitry for receiving the voice signal is adapted for connection to a microphone in a headset connected to the first electronic communications device. Also the use of the microphone in a headset reduces the risk of acoustic feedback from microphone to loudspeaker, and again the headset is often more convenient for the user.

As mentioned, the invention further relates to a karaoke device comprising a display, circuitry for reading text data and presenting corresponding text on said display, circuitry for reading music data and providing a corresponding music signal, circuitry for receiving a voice signal representing the voice of a user, circuitry for providing a first output signal comprising at least the music signal, and circuitry for providing a second output signal by mixing of the music signal and the voice signal.

When the karaoke device further comprises a transmitter for wireless transmission of said second output signal to at least one further communications device, people listening to these devices may be located at any location and still participate in the karaoke performance, as long as the location can be reached by the communication.

When the karaoke device is a portable device an even more flexible system is achieved, because the device can be carried by the user, even if he moves around from one location to another. In an expedient embodiment of the invention the karaoke device is a mobile telephone.

In an alternative embodiment the karaoke device is a Bluetooth device, which will be an interesting solution with the increasing use of Bluetooth in many buildings. The device may also be a Personal Digital Assistant, since the use of these devices is also increasing.

The karaoke device may comprise circuitry for reproducing the first output signal for the user. Alternatively, the circuitry for reproducing the first output signal may be adapted for connection to a loudspeaker in a headset connected to the karaoke device. The use of the loudspeaker in a headset reduces the risk of acoustic feedback from microphone to loudspeaker, and in many situations the headset is also more convenient for the user.

Similarly, the voice signal of the user, i.e. the singer, may be received by a microphone integrated in the karaoke device. In an alternative embodiment the circuitry for receiving the voice signal is adapted for connection to a microphone in a headset connected to the karaoke device. Also the use of the microphone in a headset reduces the risk of acoustic feedback from microphone to loudspeaker, and again the headset is often more convenient for the user.

### BRIEF DESCRIPTION OF THE DRAWINGS

The invention will now be described more fully below with reference to the drawings, in which

FIG. 1 shows a karaoke system according to the invention,

FIG. 2 shows an example of the implementation of a karaoke device according to the invention,

FIG. 3 shows a flow chart illustrating the karaoke function of the invention,

FIG. 4 shows a karaoke system with several listeners,

FIG. 5 shows a karaoke system with two mobile telephones for the singer,

FIG. 6 shows the use of a headset together with a karaoke device,

FIG. 7 shows a karaoke system with a Bluetooth headset,

FIG. 8 shows a karaoke system with a PDA, and

FIG. 9 shows a karaoke system where music data can be downloaded or streamed to a karaoke device from a remote server.

### DETAILED DESCRIPTION OF EMBODIMENTS

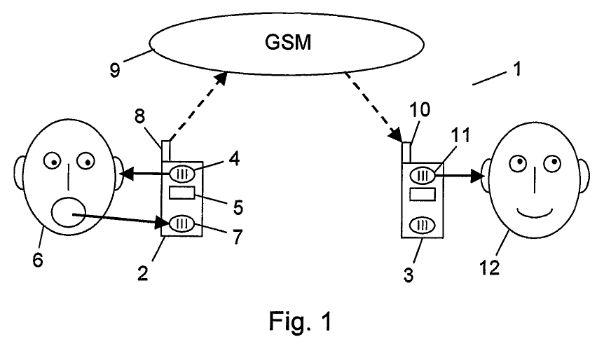

FIG. 1 shows an example of the use of the invention. In the example a karaoke system 1 is implemented by means of two karaoke devices in the form of the mobile telephones 2 and 3. The mobile telephone 2 is equipped according to the invention, while the telephone 3 may be either a standard mobile telephone or a mobile telephone equipped according to the invention. In FIG. 1 the mobile telephones are illustrated as phones connected to a GSM network, but other types, such as UMTS, GPRS or DECT phones, can be used as well. Also normal stationary telephones may be used. As will be mentioned later, also other types of electronic communications devices may be used.

As will be described in more detail below, the mobile telephone 2 can reproduce the music of a song through the loudspeaker 4 and show the corresponding text of the song on the display 5. A singer 6 listens to the music from the loudspeaker 4 and reads the text on the display 5, which enables him to sing the song into the microphone 7. In the device 2 the voice of the singer is combined with the music and transmitted through the antenna 8 and the GSM network 9 to the other mobile telephone 3, where the combined signal is received by the antenna 10 and reproduced through the loudspeaker 11 to a listening person 12 representing an audience to the karaoke performance.

It is noted that the sound reproduced by the loudspeaker 4 may be the music signal alone or the music signal combined with the voice of the singer. In the latter case, the voice signal may be modified electronically to provide an improved experience of the singer. Thus this combined signal is not necessarily identical to the one transmitted to the other phone 3.

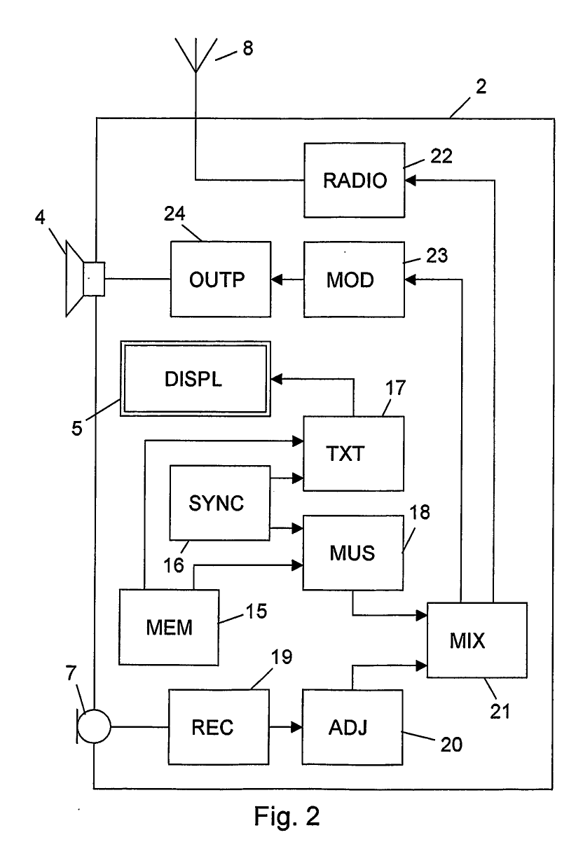

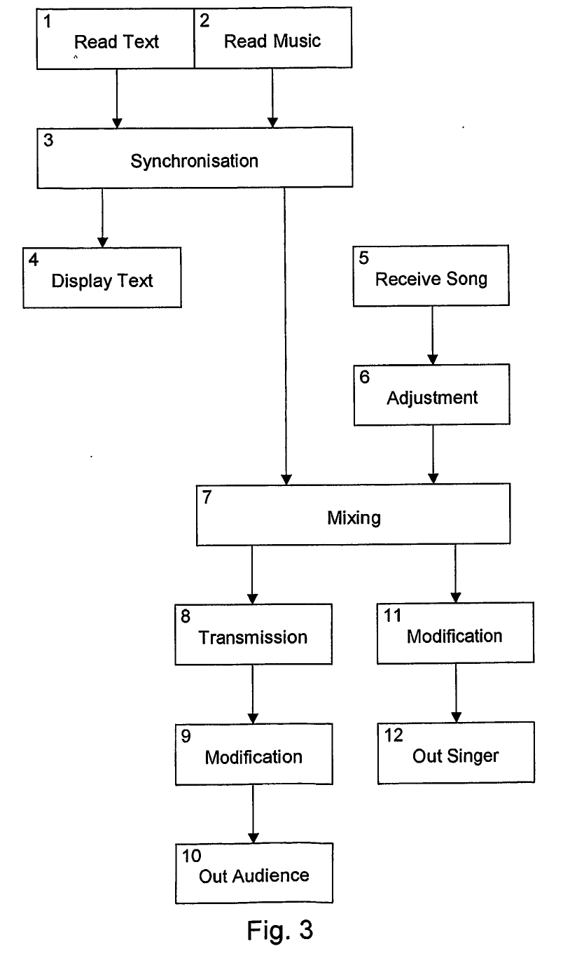

FIG. 2 shows an example of how the karaoke device/mobile telephone 2 may be implemented. As mentioned, the device contains circuitry for the karaoke function as well as the circuitry of a normal mobile telephone. For reasons of clarity only those parts of the normal telephone circuitry needed together with the karaoke function are illustrated. FIG. 3 is a flow chart illustrating the function of the system of FIG. 1, and the function will now be described with reference to FIGS. 2 and 3.

In steps 1 and 2 the data representing the text and the music of a song are read. In the case illustrated in FIGS. 2 and 3 the data of the song are stored in a memory 15 in the phone 2, but as will be mentioned later, this is only one of several possibilities. In addition to the text and the music, optional mood setting pictures to be displayed together with the text of the song may also be stored. The data may be stored in different formats. One possibility could be the planned SMIL multimedia files combining MP3 music, text and optional pictures.

The playing of the music and the display of the text must be synchronized as illustrated in step 3. This synchronisation is provided by the synchronisation circuit 16 in combination with the text unit 17 and the music unit 18. If the SMIL format is used, the synchronisation is done through that format. If the music and the text are stored in different formats, the text may be controlled by time settings included in the recording of the music, or, although less optimal, the music may be controlled by time settings built into the text. If desired, a speed adjustment may be included, making it possible to adjust the speed of the music and the text.

In step 4 the text from the text unit 17 is then displayed on the display 5, which is the normal display also used for other purposes in the mobile telephone 2. In case mood creating pictures are also used, these will be displayed on the display together with the text.

The singer will now read the displayed text and listen to the corresponding music, which is reproduced through the loudspeaker 4, and in parallel to the music he will sing into the microphone 7, which is here the normal microphone of the mobile telephone. The voice of the singer from the microphone 7 is received by the receiving circuit 19 as illustrated in step 5.

In step 6 the song is adjusted in the adjustment circuit 20 in different ways. The volume compared to the music is set, and in order to compensate for the small microphone and to make the song sound better e.g. more bass and echo may be added.

As illustrated in step 7 the adjusted voice signal from the singer is then added to or mixed with the music signal from the music unit 18 to create a combined signal. This mixing process is performed in the mixer 21. As shown, the mixer 21 may provide two output signals, one to the singer and one to the audience. As mentioned earlier, these signals may be either identical or different.

Step 8 now illustrates an important aspect of the invention. The combined signal intended for the audience is transmitted from the mixer 21 through the radio circuit 22, which is the normal radio circuit of the mobile telephone, the antenna 8 and the GSM network shown in FIG. 1 to the other device 3, which is another mobile telephone in this case.

In the other telephone 3 the received signal may be modified in different ways as illustrated in step 9. As an example, artificial and additionally amplified harmonics and artificial and additionally amplified bass may be generated and added to the signal to compensate for the filtering away of sounds above and below the normal phone frequency range. Similar or other modifications to the signal may also be performed in order to enhance the sound reproduced to the audience. In the latter case such modifications could also have been added to the signal in the mobile telephone 2 before the signal was transmitted to the mobile phone 3, i.e. between the mixer 21 and the radio circuit 22.

After the modification in step 9 the resulting signal is then played in the loudspeaker 11 to be heard by the audience, which is here represented by the listening person 12. This is illustrated in step 10.

The output signal from the mixer 21 intended for the singer may also be modified in order to enhance the sound reproduced. This is shown in step 11 and takes place in the modifying circuit 23. If no further modification is needed, this step can be avoided.

Finally, step 12 shows that this signal is played through the output circuit 24 and the loudspeaker 4 to be heard by the singer. Also the loudspeaker 4 is the normal loudspeaker of the mobile telephone 2.

The system as described above may be modified in several ways.

As mentioned earlier, the system may be simplified in such a way that the sound reproduced to the singer by the loudspeaker 4 does not contain the feedback of the singer's own voice. In that case the input of the modifying circuit 23 may be connected directly to the output of the music unit 18 instead of the mixer 21. However, in most situations the feedback to the singer will be preferred, because it provides the singer with an enhanced experience.

In FIG. 1 only one listener, i.e. the person 12, is illustrated. However, in most karaoke applications the audience will include several listeners. This will be possible if the mobile telephone 3 has a loudspeaking function allowing several people to listen to the loudspeaker 11. The telephone 3 may also be connected, e.g. by a cable, to an external loudspeaker or an audio equipment having its own loudspeakers. Alternatively, the device 3 could be an audio equipment provided with a GSM receiver.

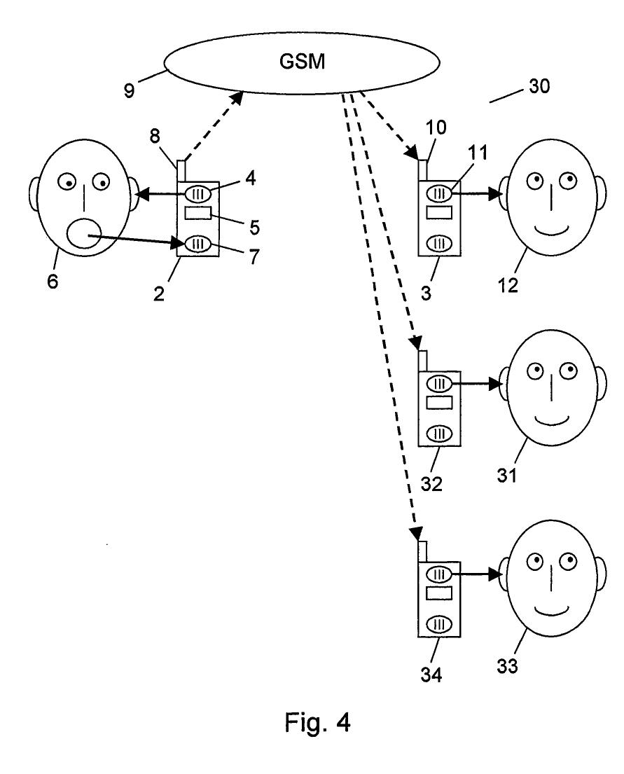

A more flexible solution is illustrated in FIG. 4 illustrating a system 30, where the signal from the mobile telephone 2 in addition to the mobile telephone 3 is transmitted to the further mobile telephones 32 and 34 allowing the persons 31 and 33 to listen to the karaoke performance on their own mobile telephones. Of course the number of telephones may be further increased corresponding to the size of the actual audience. The persons 12, 31 and 33 may be present in the same room, e.g. the room in which also the singer is present. This situation corresponds to a normal karaoke performance where all participants are in the same room. However, this solution also allows a distributed karaoke performance in which the participants are placed in different locations. As an example, each person may be in his own home. Thus a group of people can enjoy a karaoke performance together at a short notice without having to leave their home.

In FIG. 4 the karaoke functions must be implemented in the mobile telephone 2, while the telephones 3, 32 and 34 may be normal mobile telephones. However, a more interesting situation is obtained when each member of the group has a mobile telephone in which the karaoke functions are implemented, because it will allow any one of the group participants to be the singer. If e.g. the person 33 wants to be the singer, the karaoke functions will be performed from the telephone 34, while the other telephones will now be in the listening mode.

In FIG. 1 the mobile telephone 2 is shown to provide the microphone 7 for the singer as well as the loudspeaker 4 and the display 5. In a practical situation this solution is not optimal. One problem is that it will hardly be possible to watch the display 5 when the loudspeaker 4, and thus the complete phone, has to be held close to the ear of the singer in order to listen to the music. While this situation could be overcome by the use of an external display connected to the phone, another problem is the risk of acoustic feedback between the microphone 7 and the loudspeaker 4 resulting in an unwanted acoustical echo.

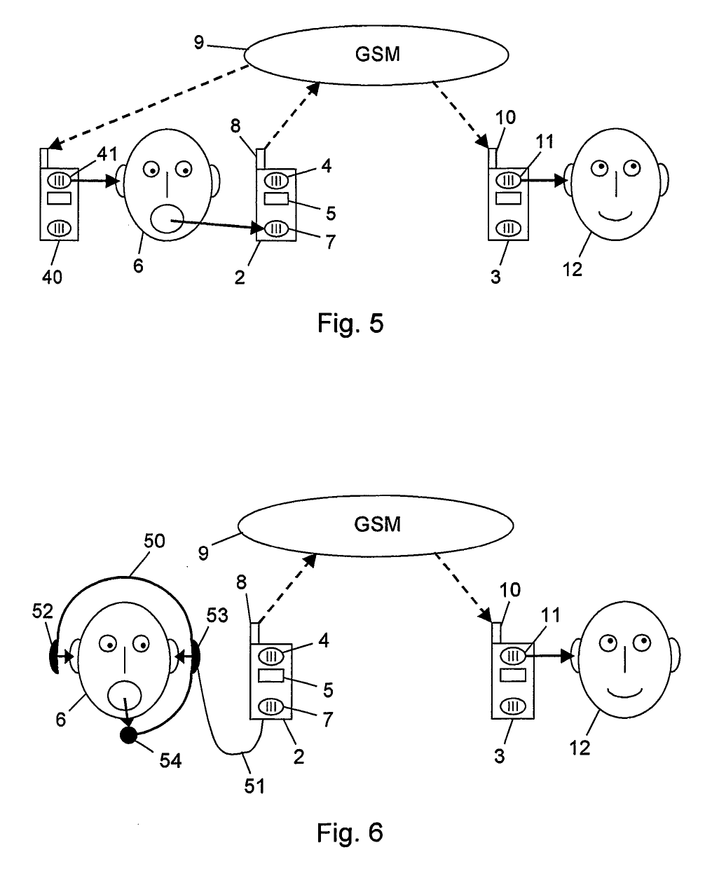

FIG. 5 shows a solution to these problems. Here the singer utilizes a second mobile telephone 40, and its loudspeaker 41, to listen to the music. This telephone can then be held to the ear while the singer watches the display 5 and sings into the microphone 7 of the phone 2. The output signal intended for the singer is then transmitted via the GSM network 9 from the phone 2 to the phone 40. This can be implemented by connecting the singer output signal from the mixer 21 in FIG. 2 to the radio circuit 22 instead of the modifying circuit 23. Alternatively, the signal intended for the audience can be used also by the singer. The singer could then just use one of the other phones in FIG. 4 to provide the music.

FIG. 6 shows another embodiment which also solves the above-mentioned problems. Here a headset 50 is connected to the mobile telephone 2 with a cable 51. The headset 50 is equipped with loudspeakers 52 and 53 and a microphone 54. The singer sings into the microphone 54 and listens to the music through the loudspeakers 52 and 53. He still watches the display 5 of the phone 2. It should be noted that it would also be possible to use the microphone 54 in the headset in combination with the loudspeaker 4 in the phone 2, or the microphone 7 in the phone 2 together with the loudspeakers 52 and 53 in the headset. Instead of the cable 51 the headset 50 could also be connected to the phone 2 by means of a short-range radio link, such as a Bluetooth link.

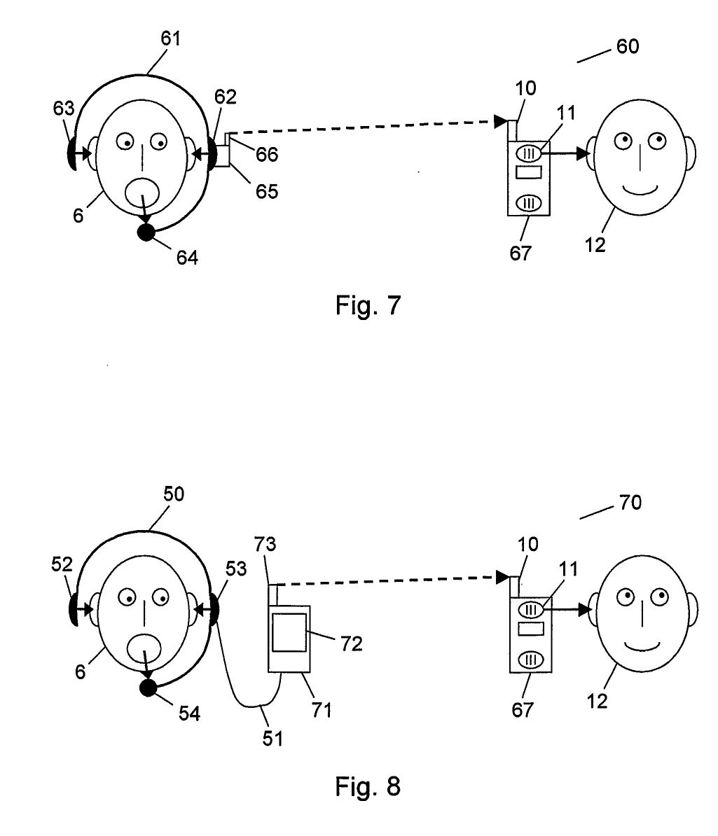

Another embodiment of the invention is shown with the system 60 in FIG. 7. Also here a headset is used. However, in this embodiment the circuitry for performing the karaoke function is integrated into the headset 61. Similar to the headset 50 in FIG. 6 the headset 61 has loudspeakers 62 and 63 and a microphone 64. Additionally, the headset 61 comprises circuitry 65 and an antenna 66 for a short-range radio link, such as a Bluetooth link. As mentioned above, headsets with Bluetooth transmitters/receivers already exist, so the only modification needed is the additional karaoke circuitry similar to the one shown in FIG. 2 for the mobile telephone 2. A display for showing the text may be connected to the headset e.g. through a cable or another Bluetooth link. Instead of transmitting the combined signal intended for the audience through a GSM network like in FIG. 1, the signal is here transmitted directly to a Bluetooth receiver. In FIG. 7 the Bluetooth receiver is illustrated as a mobile telephone 67, since many mobile telephones are already equipped with Bluetooth receivers. However, any other device having a Bluetooth receiver could be used. As an example an audio equipment could be provided with a Bluetooth receiver and thus reproduce the karaoke sound for an audience.

It is noted that Bluetooth and GSM may also be combined. As an example a Bluetooth headset like the one in FIG. 7 could transmit the combined signal to a Bluetooth receiver in e.g. a mobile telephone, from which the signal could be transmitted through a GSM network to a number of other mobile telephones similar to the situation in FIG. 1 or FIG. 4.

In FIG. 8 an embodiment of the karaoke system 70 using a Personal Digital Assistant (PDA) 71 is illustrated. The karaoke functions from FIG. 2 are here integrated into the PDA 71 having a display 72 larger than the display 5 of the mobile telephone 2. Just like the telephone 2 in FIG. 6 the PDA 71 is connected to a headset 50 with a cable 51. The headset functions as described in FIG. 6. The PDA 71 further has a Bluetooth antenna 73 from which the combined signal can be transmitted to the Bluetooth receiver 67 which can be identical to the one described in FIG. 7.

In the embodiments described above the data representing the text and the music of a song to be used in a karaoke performance were stored in a memory 15 in the karaoke device, e.g. the mobile telephone 2. This solution has the limitation that typically only a few different songs can be stored due to the limited storage capacity of the memory 15. Instead of the internal memory 15 an external memory in the form of e.g. a memory card may be used, provided that the device is equipped with the necessary hardware for the insertion of such a memory card into the device. An accessory device including the memory and connectable to the karaoke device, e.g. the mobile phone 2, may also be used. These solutions provide a better but still limited selection of different songs.

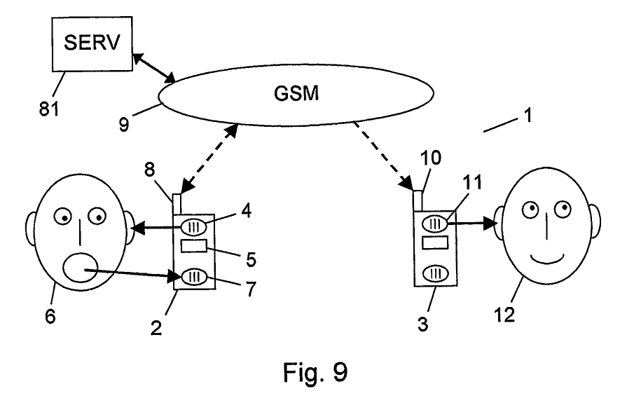

A different solution providing a much larger selection of different songs is illustrated in FIG. 9. A remote server 81 having a large selection of different songs is connected to the GSM network 9, e.g. through the Internet. When a user, e.g. the singer 6, wants a specific song for a karaoke performance, this song may be requested from the server 81 by the mobile telephone 2. Subsequently the data corresponding to the requested song are downloaded or streamed to the telephone 2.

When the data are downloaded, they will typically be stored in the memory 15 in the telephone 2, and then afterwards they can be read therefrom, as was described in relation to FIG. 2. Thus the only modification of FIG. 2 is a connection from the radio circuit 22 to the memory 15 allowing the data to be stored, but such a connection will normally be in the mobile telephone anyway.

In the case of streaming, the data are transmitted to the mobile phone 2 during the karaoke performance, and the music and the text will then be generated as the data are received. However a buffer is needed in order to avoid any gaps in the music due to transmission errors or delays. Normally, the memory 15 can be used as the buffer, and thus the circuit can be similar to the downloading case.

Although a preferred embodiment of the present invention has been described and shown, the invention is not restricted to it, but may also be embodied in other ways within the scope of the subject-matter defined in the following claims.

1. A method of performing a karaoke function from a first electronic communications device, said method comprising the steps of:
reading music data and providing a corresponding music signal,
reading text data and presenting corresponding text on a display,
receiving a voice signal representing the voice of a user (6),
providing a first output signal comprising at least the music signal,
providing a second output signal by mixing of the music signal and the voice signal, and
reproducing said first output signal for the user,
wirelessly transmitting said second output signal from the first electronic communications device to at least one further communications device,
receiving said second output signal in the at least one further communications device, and
reproducing said second output signal for an audience in the at least one further communications device.

2. A method according to claim 1, wherein the first electronic communications device is a portable device.

3. A method according to claim 2, wherein the first portable, electronic communications device is a mobile telephone.

4. A method according to claim 1 wherein the at least one further communications device comprises a mobile telephone.

5. A method according to any one claim 1 wherein the step of reading music data comprises reading data stored in the first electronic communications device.

6. A method according to claim 1 wherein the step of reading music data comprises streaming of data from a server to the first electronic communications device.

7. A method according to claim 1 wherein the receiving of the voice signal comprises the use of a microphone in a headset connected to the first electronic communications device.

8. A method according to claim 1 wherein the reproduction of the first output signal for the user comprises the use of a loudspeaker in a headset connected to the first electronic communications device.

9. A system for performing a karaoke function, comprising a first electronic communications device and at least one further communications device, wherein said first electronic communications device comprises:
a display,
circuitry for reading text data and presenting corresponding text on said display,
circuitry for reading music data and providing a corresponding music signal,
circuitry for receiving a voice signal representing the voice of a user,
circuitry for providing a first output signal comprising at least the music signal,
circuitry for providing a second output signal by mixing of the music signal and the voice signal,
a transmitter for wireless transmission of said second output signal to the at least one further communications device, and
the at least one further communications device comprises:
a receiver for receiving said second output signal, and means for reproducing said second output signal for an audience.

10. A system according to claim 9, wherein the first electronic communications device is a portable device.

11. A system according to claim 10, wherein the first portable, electronic communications device is a mobile telephone.

12. A system according to claim 9 wherein the at least one further communications device comprises a mobile telephone.

13. A system according to claim 9 wherein the first electronic communications device comprises circuitry for reproducing said first output signal for the user.

14. A system according to claim 13, wherein said circuitry for reproducing the first output signal is adapted for connection to a loudspeaker in a headset connected to the first electronic communications device.

15. A system according to claim 9 wherein the circuitry for receiving the voice signal is adapted for connection to a microphone in a headset connected to the first electronic communications device.

16. A karaoke device comprising:
a display,
circuitry for reading text data and presenting corresponding text on said display,
circuitry for reading music data and providing a corresponding music signal,
circuitry for receiving a voice signal representing the voice of a user,
circuitry for providing a first output signal comprising at least the music signal,
circuitry for providing a second output signal by mixing of the music signal and the voice signal, and
a transmitter for wireless transmission of said second output signal to at least one further communications device.

17. A karaoke device according to claim 16, wherein the device is portable.

18. A karaoke device according to claim 17, wherein the device is a mobile telephone.

19. A karaoke device according to claim 17, wherein the device is a Bluetooth device.

20. A karaoke device according to claim 17, wherein the device is a Personal Digital Assistant.

21. A karaoke device according to claim 16, wherein the device comprises:
circuitry for reproducing said first output signal for the user.

22. A karaoke device according to claim 21, wherein said circuitry for reproducing the first output signal is adapted for connection to a loudspeaker in a headset connected to the karaoke device.

23. A karaoke device according to claim 16, wherein the circuitry for receiving the voice signal is adapted for connection to a microphone in a headset
connected to the karaoke device.
